(19) United States
(12) Patent Application Publication
(10) Pub. No.: US 2008/0115636 A1
(43) Pub. Date: May 22, 2008

(54) RADIO FREQUENCY IDENTIFICATION ENABLED WRENCH SYSTEM AND A METHOD OF OPERATING THE SAME

(75) Inventors: Lynn Ann DeRose, Gloversville, NY (US); Douglas Roy Forman, Niskayuna, NY (US); Craig Douglas Young, Maineville, OH (US); Michael Orlando Cimini, Fairfield, OH (US); Gregory Alan Richardson, Cary, NC (US); James Nelson Bratton, Cary, NC (US); Lee Roy LaPierre, Woburn, MA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric, Schenectady, NY (US)

(21) Appl. No.: 11/560,990

(22) Filed: Nov. 17, 2006

(51) Int. Cl. B25B 23/144

(52) U.S. Cl. 81/479

(57) ABSTRACT

A radio identification enabled wrench system is disclosed. The system includes a template having multiple RFID tags. The template also corresponds to a part associated with a particular fastener that is associated with each of the multiple RFID tags. The system further includes a torque wrench having a RFID reader and a RFID antenna and a means for identifying what fastener the wrench is being used upon and whether the correct torque has been applied to the fastener and configured to provide a feedback for a user. The system includes a means for transferring data that may be either wired or wireless.

### BACKGROUND

The invention relates generally to radio frequency communication systems, and more particularly to automatic radio frequency identification systems.

Radio frequency identification (RFID) is a technology of remotely storing and retrieving information using devices such as a RFID tag or a transponder that communicates via radio frequency. A RFID tag is a small object such as an adhesive sticker that may be attached to or incorporated into a product. Data from the RFID tag is read by a RFID reader and processed according to the needs of a particular application. The data transmitted by the RFID tag may provide identification or location information, or specifics about the tagged product, such as price, color and date of purchase. Chip based RFID tags contain multiple silicon chips and antennas.

Assembly processes, such as assembly of aircraft engine parts, require tightening of nuts and bolts in a particular order or sequence. In order to tighten the nuts and bolts sequentially, the operator must keep track of which fasteners have been tightened already, and which fastener is next in sequence. In many assembly processes, it is necessary to retorque a nut or a bolt several times in the course of the sequence of tightening of fasteners. However, this technique is cumbersome and involves risks due to human error.

Therefore, a need exists for an improved RFID system that may address one or more of the problems set forth above.

### BRIEF DESCRIPTION

In accordance with an embodiment of the invention, a radio frequency identification enabled wrench system is provided. The system includes a template having multiple RFID tags. The template also corresponds to a part associated with a particular fastener that is associated with each of the multiple RFID tags. The system also includes a torque wrench having a RFID reader and a RFID antenna and a means for identifying what fastener the wrench is being used upon and whether the correct torque has been applied to the fastener. The system is configured to provide a feedback for a user.

In accordance with another embodiment of the invention, a method of operation is provided. The method includes providing a torque wrench and at least one reader associated with a part on a template. The method also includes providing an indication for correct alignment of the wrench with a fastener to be tightened. The method also includes providing an indication for an appropriate amount of torque applied to the fastener. The method further includes providing an indication for sequential tightening of the fasteners.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an exemplary torque wrench with a RFID reader;

FIG. 2 is a diagrammatical illustration of a section of an aircraft engine flange including fasteners and attached to a template including RFID tags;

FIG. 3 is a diagrammatical illustration of a RFID enabled torque wrench of FIG. 1 tightening the fasteners of FIG. 2; and

FIG. 4 is a flow chart illustrating exemplary steps for a method of operation of a RFID enabled torque wrench system.

### DETAILED DESCRIPTION

As discussed in detail below, embodiments of the present invention include a radio frequency identification (RFID) torque wrench system and a method of operating the same. Mechanical and digital torque wrenches are used throughout assembly and production facilities for assembly of various types of equipment, such as aircraft engine assemblies. A torque wrench is a wrench that can precisely set the torque used when tightening a fastener such as a nut or a bolt and provides a user with feedback in a manual form or a digital form to indicate when a desired amount of torque has been applied.

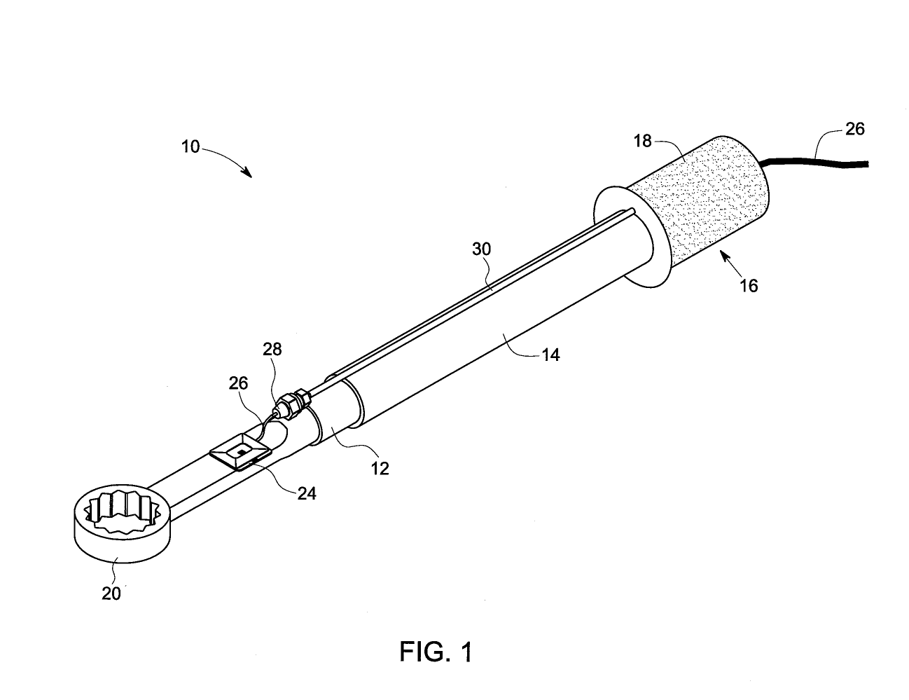

In an illustrated embodiment of the invention as shown in FIG.1, a RFID torque wrench 10 is shown. The torque wrench 10 is of a type that is adapted to tighten fasteners to a specified torque with a high degree of accuracy. In an example, the torque wrench may be adapted to rotate fasteners to a torque within about plus or minus one percent of an indicated torque. In a particular embodiment, the torque wrench 10 may be a digital torque wrench. In another embodiment, the torque wrench 10 may be manual and configured to provide an analog output. The torque wrench 10 may include a sensor (not shown) inside a handle 12. In a non-limiting example, the sensor may include a transducer. The sensor inside the handle 12 may provide feedback to a user as to when an exact amount of torque has been applied. A mounting tube 14 for a RFID transmitter antenna may be connected to a handle grip 16 providing an area for grasping of the torque wrench 10. In order to facilitate gripping, the handle grip 16 may be etched or provided with an elastomeric or a tactile covering 18. The torque wrench 10 includes a head 20 that is connected to the torque wrench 10. A RFID reader antenna 24 may be attached onto the torque wrench 10 and is configured to retrieve ID of a RFID tag on a fastener. The RFID reader antenna 24 is connected via electrical wires 26 to an inlet 28 of a thin tube 30. The RFID reader device (not shown) is embedded in the handle 12 of the torque wrench 10 and the electrical wires 26 attaching the antenna 24 pass through a thin tube 30 attached to the handle grip 16 at an opposite end and lead out of the handle grip 16. The electrical wires 26 from the handle grip 16 may then be connected to a central database for measuring the output. In a particular embodiment, the handle 12 may also contain a wireless device to allow for wireless transmission of the data back to a central database.

In a particular embodiment, the torque wrench 10 may include different types of sensors for signaling when a torque has been achieved such as a ratchet type of assembly wherein each rotation or click of the ratchet represents a discrete level of torque being applied. In another embodiment, the torque wrench 10 may include a bendable beam type wrench having a strain gauge, whereby a user is provided with an indication as to a torque being applied by observing degree of deflection of the bendable beam relative to the strain gauge. In another example, the torque wrench 10 may be handheld. In an embodiment, the torque wrench 10 may include a sensor configured to indicate when an appropriate amount of torque has been applied.

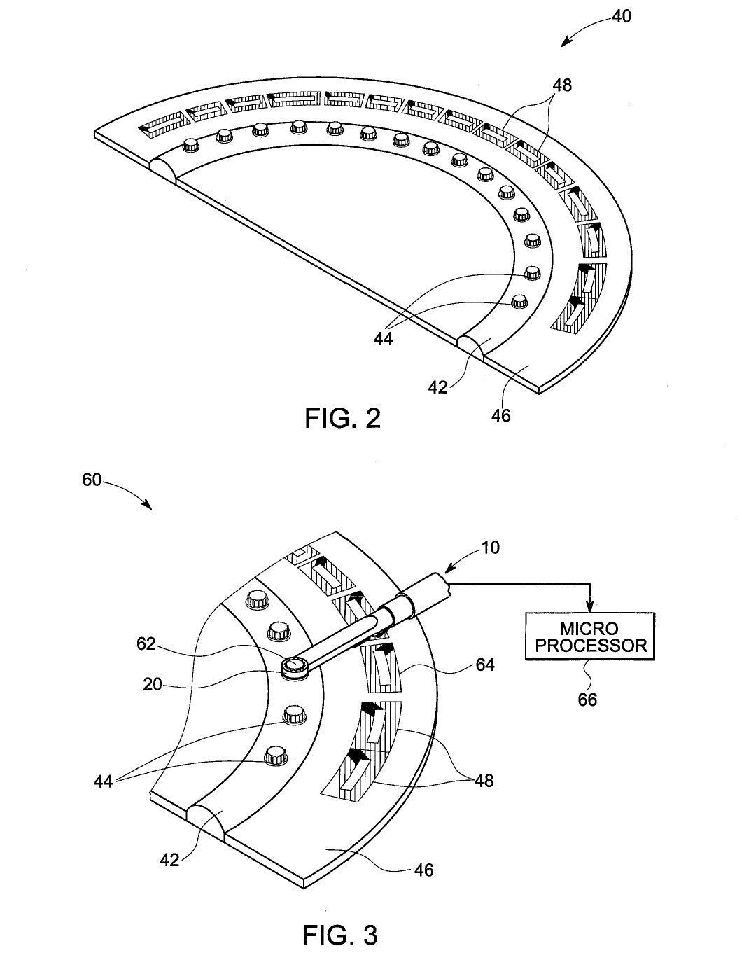

In another illustrated embodiment of the invention as shown in FIG. 2, a RFID fastener assembly 40 is depicted. The RFID fastener assembly 40 may include a section of an engine flange 42 with a series of fasteners 44. Some non-limiting examples of fasteners may include nuts and bolts. A template 46 may be attached to the flange 42 as shown. The template 46 includes a series of RFID tags 48 such that each RFID tag 48 corresponds to a fastener 44. In this embodiment, the template 44 is shown semi-circular. Various shapes of the template 46 may be included in other embodiments. In one example, the template 46 may be made of polyvinyl chloride. In another example, the template 46 may include a tape of polymer or nylon.

FIG. 3 is a diagrammatical illustration of a RFID enabled torque wrench system 60. The RFID wrench system 60 includes a RFID torque wrench 10 as referenced in FIG. 1 that is used to tighten a series of fasteners 44 as referenced in FIG. 2 on a section of flange 42 as referenced in FIG. 2. A template 46 as referenced in FIG. 2 with a series of RFID tags 48 is attached on an outside of the flange 42. As head 20 as referenced in FIG. 1 of the torque wrench 10 approaches the fastener 62, the RFID reader of FIG. 1 in the torque wrench 10 identifies the ID of the particular fastener 62 using information stored in the corresponding RFID tag 64. Output from the torque wrench 10 identifying the fastener 62 is transmitted to a microprocessor 66 at a workspace. The microprocessor 66 outputs to a user if the fastener 62 is in a desired sequence. In addition, when the torque wrench 10 tightens the fastener 62, an output of amount of torque being applied is sent to the microprocessor 66. The microprocessor 66 also outputs an appropriate amount of torque to be applied to the torque wrench 10 and informs the user when appropriate amount of torque has been applied. The microprocessor 66 may also record information data concerning the fasteners 44 that have already been tightened. The user may retrieve the recorded data to get an update about a next fastener 44 that needs to be bolted in a sequence. In addition, the microprocessor 66 may maintain an engine configuration and history automatically that can be referenced at a later time if needed. This enables the user to know where one is in a sequence of tightening the fasteners 44 in case of any interruption.

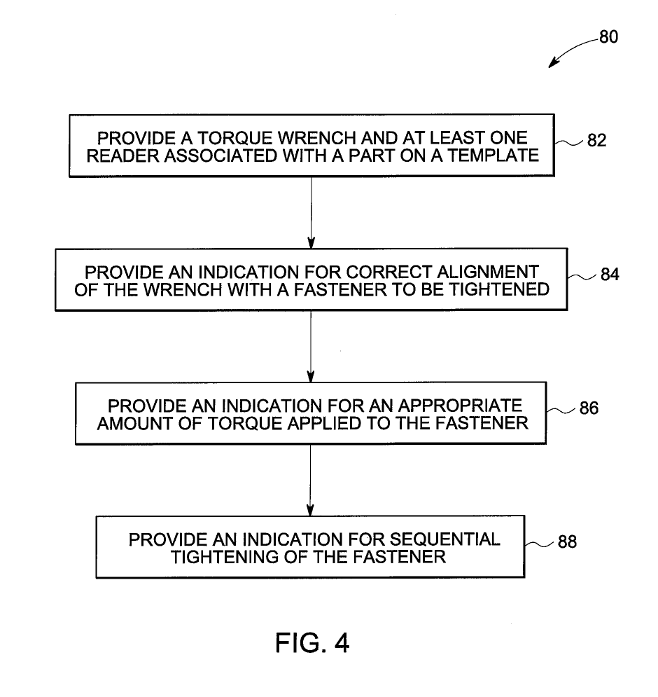

FIG. 4 is a flow chart representing exemplary steps involved in an exemplary method 80 of operation of a RFID torque wrench system. The method 80 includes providing a torque wrench with a RF reader associated with a part of a template including a series of RFID tags in step 82. As the torque wrench including the RF reader is positioned near a fastener, a microprocessor provides an indication for correct alignment of the wrench with a fastener that is to going be tightened in step 84. In a particular embodiment, the indication is provided by displaying a specific color on a screen of a microprocessor used by a user. In another embodiment, the indication may be provided on the screen. Once the alignment is correct, an indication is provided to the user to apply an appropriate amount of torque to the fastener in step 86. In a particular embodiment, the indication is provided by displaying a specific color on a screen of a microprocessor used by a user. In another embodiment, the indication may be provided by displaying a specific message on the screen. In another example, the indication when an appropriate amount of torque is applied may be provided on the screen. Further, after providing the appropriate amount of torque to the fastener, an indication is provided to the torque wrench as to the next fastener to be tightened in a sequential manner in step 88. In a particular embodiment, the method 80 may further include recording data of events on a microprocessor. In an example, recording data may include storing information regarding amount of torque applied and storing information regarding fasteners that have already been tightened.

The various embodiments of a radio frequency identification enabled wrench system and a method for operating the same described above thus provide a way to achieve a precise way of tightening fasteners in an aircraft engine assembly. These techniques and systems also allows for exact measurement of tightness of the fastener.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a torque wrench with a wireless RFID reader described with respect to one embodiment can be adapted for use with a template made of nylon and including RFID tags described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A radio frequency identification enabled wrench system comprising:
a template comprising a plurality of RFID tags, the template corresponding to a part associated with a particular fastener associated with each RFID tag;
a torque wrench comprising a RFID reader and a RFID antenna and a means for identifying what fastener the wrench is being used upon and whether the correct torque has been applied to the fastener and configured to provide a feedback for a user; and
a microprocessor configured to:
automate and record data received from the torque wrench; and
communicate information back and forth with the torque wrench and the user, the information comprising:
a desired amount of torque to be applied to the fastener;
a desired sequence of tightening; and
history of a plurality of fasteners previously tightened.

2. The system of claim 1, wherein the template comprises a tape of polymer or nylon.

3. The system of claim 1, wherein the torque wrench comprises a sensor configured to indicate when an appropriate torque has been applied.

4. (canceled)

5. The system of claim 1, wherein the fastener comprises a bolt.

6. The system of claim 1, wherein the feedback comprises display of a torque setting to the user.

7. The system of claim 1, wherein the feedback comprises display of a location of the torque wrench to the user.

8. The system of claim 1, wherein the feedback comprises display of the torque applied to the fastener by the torque wrench to the user.

9. The system of claim 1, wherein the torque wrench is handheld.

10. A method of operation comprising:
locating a template on a part, the template having a plurality of tags disposed upon it and the part having a plurality of fasteners to be tightened, the template being disposed upon the part such that each of the plurality of tags is associated with a particular fastener;
placing a torque wrench onto a first fastener of the plurality of fasteners;
detecting the tag on the template associated with the first fastener using a reader attached to the torque wrench;
sending the information identifying the tag on the template from the reader to a microprocessor;
looking up a correct alignment of the torque wrench with the first fastener;
providing an indication of the correct alignment of the wrench with the first fastener;
providing an indication for the appropriate amount of torque: that includes a reader capable of detecting the tag associated with the fastener;
determining the next fastener of the plurality of fasteners to be tightened in sequence; and
providing an indication of which fastener among the plurality is the next fastener to be tightened in sequence.

11. The method of claim 10, further comprising recording data using the microprocessor.

12. The method of claim 10, wherein providing an indication for the correct alignment comprises displaying a specific color on a screen of a user.

13. The method of claim 10, wherein providing an indication for the correct alignment comprises playing a sound on a screen of a user.

14. The method of claim 10, wherein providing an indication for the appropriate amount of torque applied comprises displaying a specific color on a screen of a user.

15. The method of claim 10, wherein providing an indication for the appropriate amount of torque applied comprises displaying a specific message on a screen of a user.

16. The method of claim 10, wherein providing an indication for the appropriate amount of torque applied comprises playing a sound on a screen of a user.

17. The method of claim 11, wherein recording data comprises storing information regarding amount of torque applied and ID of plurality of fasteners already tightened on the microprocessor.

18. The method of claim 11, wherein recording data comprises maintaining history and configuration of an engine.
